(19) United States
(12) Patent Application Publication
(10) Pub. No.: US 2005/0104536 A1
(43) Pub. Date: May 19, 2005

(54) Device and method for operating a discharge lamp

(76) Inventors: Marcel Beij, Eindhoven (NL); Arnold Willem Buij, Eindhoven (NL)

Correspondence Address: U S Philips Corporation;Intellectual Property Department, PO Box 3001, Briarcliff Manor, NY, 10510, US

(21) Appl. No.: 10/496,547

(22) PCT Filed: Nov. 6, 2002
(86) PCT No.: PCT/IB02/04676

(30) Foreign Application Priority Data
Nov. 29, 2001 (EP) 01204611.6

(51) Int. Cl. H05B 37/02

(52) U.S. Cl. 315/224; 315/291; 315/209 R

(57) ABSTRACT

The present invention relates to an operating device for a discharge lamp, comprising a power supply circuit for supplying power to the discharge lamp from a supply voltage, means for measuring at least one of the actual lamp current, the actual lamp voltage and the actual lamp power, providing at least one analogue lamp control signal representative of the lamp current, the lamp voltage and the lamp power respectively; filter means for filtering the at least one lamp control signal; control means for controlling the power supplied by the power supply circuit, wherein the at least one filtered lamp control signal is fed into the control means and the control means control the power depending on the at least lamp control signal; wherein the filter means comprise converting means for converting the at least one analogue lamp control signal to a corresponding digital lamp control signal and the filter means comprise a digital filter for filtering the digital lamp control signal into a filtered digital lamp control signal.

The present invention relates to a device and a method for operating a discharge lamp, such as a fluorescent lamp, halogen lamp etc.

Devices for operating a discharge lamps or ballasts are widely used for providing a controlled power supply to the discharge lamp. Typically, power control circuitry controls the lamp driver circuit which comprises a switched-mode power supply (SMPS) connected between the mains and the discharge lamp. The power control circuitry may be employed to optimize the preheating and ignition of the discharge lamp, to maintain a constant power to the discharge lamp for the purpose of maintaining a selected light intensity or may be used for the purpose of controlled dimming of the light intensity of the discharge lamp.

Recently digital devices for operating a discharge lamp or digital ballasts are developed wherein the power control circuitry employ digital techniques for controlling the power supplied by the switched mode power supply to the discharge lamp. Digital ballasts provide a relatively low cost control of the power, voltage and/or current supplied by the power supply. Digital ballasts are versatile as compared to the analog ballasts and allow for easier implementation of complicated control and tiing processes.

For the purpose of output power control a specific type of ballast may determine the values of one or more lamp parameters, such as the lamp voltage, the lamp current, and/or the lamp power, and use the determined values in the control process of the power supply. Consequently, the parameters values are measured and one or more signals representative of the measured parameter values are fed back into the power control circuitry. The power control circuitry uses the parameter signals to control the output voltage, output current and/or output power actually provided to the lamp by the power supply. However, the accuracy of this control process depends inter alia on the accuracy of the determined parameter signals and the sensitivity for errors in these signals.

To improve the control process the parameter signals may be filtered by using one or more analogue filters, e.g. filters including passive elements such as resistors and capacitors.

A drawback hereof is that if analogue filters are applied in a ballast, the characteristics of the filters are dependent on the applied hardware, i.e. on the specific passive elements applied. When in various situations filters with different filter characteristics are needed, the hardware used in a first situation must be replaced by different hardware in another situation.

A further drawback is that the filter characteristics remain constant after the filter is placed in the ballast. This implies that the filter characteristics of the filter cannot in general be changed once the ballast is fabricated. For example, at the end of the life of a particular lamp used, the control of the power supply may require filter characteristics of the control signal filter which differ considerably from the optimal filter characteristics in case a new lamp is used.

A still further drawback is that due to the inflexibility of the prior analogue filters, each of the parameter signals is to be filtered by a separate filter, which requires a considerable number of electronic components and renders the ballast circuitry complex.

A still further drawback is that the analogue filters are unable to adapt the filter characteristics during operation of the ballast. This may for example be needed in case an optimal power supply control during changing of the power supplied to the lamp, such as during dimming of the lamp, requires changing the filter characteristics of the filter(s).

It is an object of the present invention to improve the existing devices for operating a discharge lamp and to provide a device wherein at least one of the above-mentioned drawbacks is obviated.

According to a first aspect of the invention a device for operating a discharge lamp is provided, the device comprising:
a power supply circuit for supplying power to the discharge lamp from a supply voltage,
means for measuring at least one of the actual lamp current, the actual lamp voltage and the actual lamp power, providing at least one analogue lamp control signal representative of the lamp current, the lamp voltage and the lamp power respectively;
filter means for filtering the at least one lamp control signal;
control means for controlling the power supplied by the power supply circuit, wherein the at least one filtered lamp control signal is fed into the control means and the control means control the power depending on the at least lamp control signal; wherein the filter means comprise converting means for converting the at least one analogue lamp control signal to a corresponding digital lamp control signal and wherein the filter means comprise a digital filter for filtering the digital lamp control signal into a filtered digital lamp control signal. By applying a digital filter the filter characteristics are practically independent of the hardware used, which renders the operating device more versatile.

According to a preferred embodiment the digital filter is software-controllable. Thus, the operation of the filter, for example the characteristics of the filter, can be easily changed by simply loading an adapted version of the software controlling the filter.

In a further preferred embodiment the filter is adapted so as to control the characteristics of the digital filter during operation of the discharge lamp. The filter characteristics for example may be changed depending on certain predefined values of the measured control signal(s) or may be changed as function of the life of the lamp in use.

In a further preferred embodiment the converting means comprise a first analogue-to-digital (A/D-) converter for sampling a first lamp control signal and a second analogue-to-digital (A/D-) converter for sampling a second lamp control signal. When measuring three or more signals, the converting means may comprise three or more analogue-to-digital converters, one analogue-to-digital converter for each measured control signal. The resulting digital control signals may each be submitted to a digital filter. Preferably, however, each of the resulting digital control signals is filtered in one and the same digital filter, which further reduces the number of electronic components needed to implement the operating device.

In a further preferred embodiment the converting means comprise one analogue-to-digital (A/D-) converter for successively sampling each of the lamp control signals. In this embodiment the various measured analogue control signals are successively sampled by one and the same A/D-converter and consequently the circuit design may be simplified even further.

In a preferred embodiment of the present invention the digital filter is a first order filter, wherein the first order filter preferably processes the digital lamp control signal according to

$${O}_{N} = \frac{1}{X} {I}_{N} + \frac{X - 1}{X} {O}_{N - 1}$$

wherein O_{N} is the filtered digital lamp control signal for time point N, O_{N-1} is the filtered lamp control signal for time point N-1, I_{N} is the digital lamp control signal on time point N and X is a software-controllable filter parameter and wherein X preferably is a preset integer. A first order filter is relatively simple and the amount of program source code needed to implement a first order filter is limited.

If the need arises for a stronger filter then the digital filter may comprise two or more first order filters in series to create a second order filter and so on. However, in further preferred embodiments the second and higher order filters may be programmed directly.

In another preferred embodiment the digital filter comprises a buffer array for storing of a plurality of input samples of the digital lamp control signal and means for processing at least a part of said plurality of input samples in the buffer array to provide an output sample of the digital control signal. Although application of a buffer array may require a relatively large memory capacity, this embodiment will provide a fast and versatile digital filtering of the lamp control signal.

Preferably the buffer array has a first-in first-out (FIFO) structure, which means that input data samples are stored into an array of a number (N) of entries and that the oldest input data samples are shifted out at the moment a new sample has to be placed into the buffer array. All entries or at least a plurality of entries are used to filter the input data.

In a further preferred embodiment each sample of the plurality of input samples of the digital lamp control signal a different weight factor is applied, whereafter the weighted input samples are summed to provide the output sample of the digital control signal, preferably providing a moving average filter having a sinc-shaped frequency response.

In a preferred embodiment the filter means and control means are implemented in one microcontroller. The microcontroller comprises at least a central processing unit, a memory in which the control software may be loaded, input- and output terminals and interconnecting circuitry. The microcontroller incorporates both the function of control circuitry for the power supply and the function of filter for the control signals used by the control circuitry. Both functions may be implemented by the same software-program running on the microcontroller.

According to another aspect of the invention a method for operating a discharge lamp is provided, comprising the steps of:
measuring at least one of the actual discharge lamp current, the actual discharge lamp voltage and the actual discharge lamp power, providing at least one analogue lamp control signal representative of the lamp current, the lamp voltage and the lamp power respectively;
converting the at least one analogue lamp control signal to a corresponding digital lamp control signal;
digitally filtering the at least one lamp control signal;
providing the digitally filtered lamp control signal to a control circuit;
controlling the power supplied to the discharge lamp based on the digitally filtered lamp control signal provided to the control circuit.

Further advantages, features and details are given in the following description of two preferred embodiments of the invention. In the description reference is made to the annexed figures.

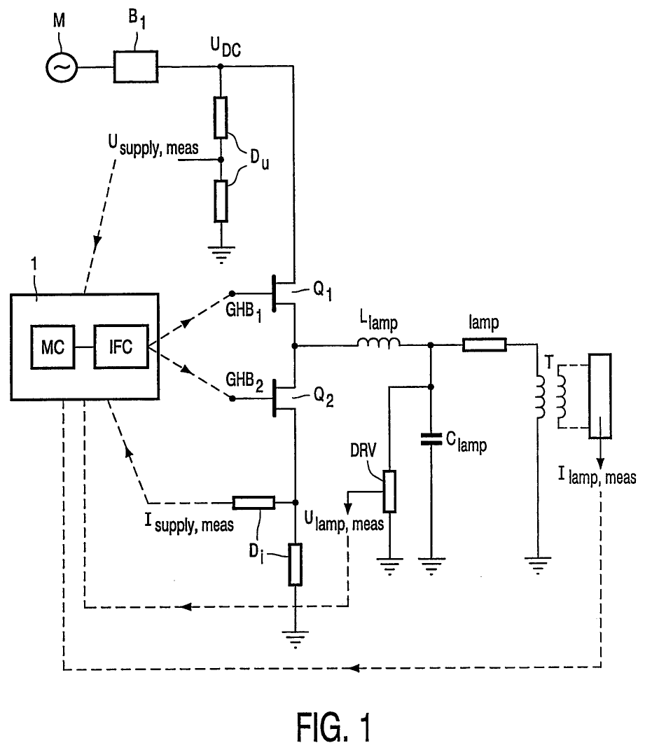

FIG. 1 is a schematic circuit diagram of a preferred device for operating a discharge lamps;

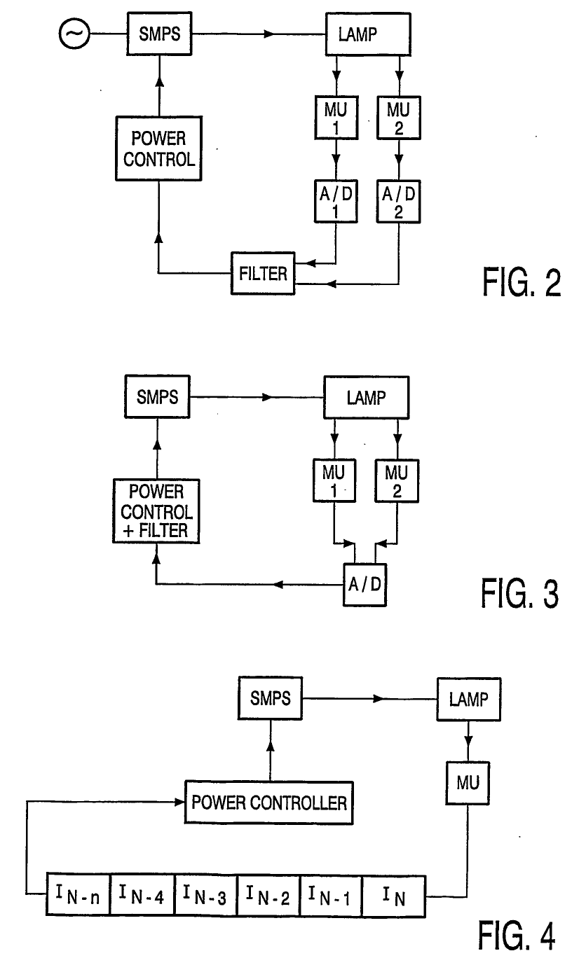

FIG. 2 is a block diagram showing a further preferred embodiment of the present invention for operating the discharge lamp; and

FIG. 3 is a block diagram showing the embodiment of FIG. 2, wherein the controller and filter are combined;

FIG. 4 is a block diagram of a further preferred embodiment of an operating device wherein a buffer array filter is used.

The lamp power supply according to a preferred embodiment of the invention is a dutycycle controlled switched mode power supply (SMPS) of the constant frequency pulse width modulation (PWM) type, which uses the same frequency for ignition, normal operation and dimmed operation of the lamp. In the embodiment shown in FIG. 1, the power supply is a half-bridge, which produces a square wave signal and serves for ignition and normal/dimmed operation of the lamp.

The switched mode power supply (SMPS) operates in the symmetrical mode. The dutycyles of the two switching elements are equal, their on-times being separated from each other by ½ of the switching period. In the ignition phase the L-C combination Lₗₐₘₚ, Cₗₐₘₚ is unloaded which generates a high voltage across the lamp. This causes ignition of the lamp. In the bum phase the L-C combination Lₗₐₘₚ and Cₗₐₘₚ is loaded by the lamp. The power delivered to the lamp is determined by the dutycycle. Hence, the lamp power supply is controlled by one parameter, the dutycycle of the switching elements.

In the block diagram of FIG. 1 a diode bridge B1 is shown, which is connected to the mains M (220 V AC). The bridge B1 rectifies the mains M and provides a DC supply voltage U_{DC} of about 400 V.

For driving the lamp a half-bridge drive circuit is shown, wherein the switching elements are formed by two power transistors (power FET's) Q1 and Q2. The gates of the switching elements Q1 and Q2 are driven by driver signals GHB1 and GHB2 originating from a control circuit to be described hereafter.

Further are shown an LC-combination Lₗₐₘₚ, Cₗₐₘₚ for driving the lamp and control circuitry for providing the control signals GHB1 and GHB2 to power transistor Q1 and Q2 respectively. As the control circuitry operates on a relatively low voltage (typical 5 V supply voltage), the input signals must be in the range from 0 to 5 V and consequently the output signals that the control circuitry can deliver are also in this range. Consequently, the control circuitry is provided with an interface circuit (IFC) for converting voltages and currents into usable indication signals and for converting control signals from the control circuitry into usable driver signals for the switching elements Q1 and Q2. The control circuitry is provided with a microcontroller (MC) including read-only memory (ROM), programmable or non-programmable, random access memory (RAM) and/or a processor, A/D-converters, D/A converters etc.. In the memory of the microcontroller control software is stored. Instead of a microcontroller a special purpose digital signal processor (DSP) may be used, which includes a CPU especially designed for digital signal processing. In a DSP extra fast instruction sequences are provided to improve the signal processing performances of the device.

Although not shown in FIG. 1, electrode heating circuits, which are used to preheat the electrodes before ignition of the lamp, and various types of protection circuits, etc. can also be provided.

The control circuitry (1) outputs, under software control, a square wave, which is averaged in the interface circuit with an RC-filter to rule out the ripple component. The resulting DC-voltage is used by the control circuitry (1) to generate the driver signals GHB1 and GHB2 for the switching elements Q1 and Q2 respectively. The driver signals GHB1 and GHB2 may in another embodiment of the invention be generated directly by the microcontroller. A level shifter (not shown) will be used to bring the driver signal GHB1 at the appropriate level. Consequently, the dutycycle, with which the power supply to the lamp is to be controlled, is determined by software stored in the memory of the microcontroller.

The functions of stabilization of the power or current in the lamp, the optimization of the ignition, preheating and electrode heating, the adaptation to different lamp types, can be achieved by adapting the software running on the microcontroller. These functions are implemented by a digital control loop for which the microcontroller performs measurements of a plurality of physical quantities or parameters such as the current in the lamp, the voltage across the lamp, the supply current and supply voltage.

One of the parameters may be the current Iₗₐₘₚ running in the lamp. Iₗₐₘₚ can be determined in various ways. In the embodiment of FIG. 1, Iₗₐₘₚ is determined by a lamp current transformer T, the primary windings of which are connected between an electrode of the lamp and ground. The voltage of the secondary windings of the lamp current transformer T is rectified in a bridge circuit (not shown) and averaged. The resulting analogue signal I_{lamp,meas} is representative of the lamp current Iₗₐₘₚ.

Another parameter may be the actual voltage Uₗₐₘₚ across the lamp. Uₗₐₘₚ can be determined in various ways. In the embodiment of FIG. 1, Uₗₐₘₚ is represented by the resulting analogue voltage U_{lamp,meas} taken from the high-ohmic divider and rectifier circuit (DRV).

The above mentioned parameters may be determined using relatively fast A/D-converters which are able to perform a high frequency sampling of the relevant parameter signals.

A further parameter may be the supply current I_{supply}, which is represented by the averaged voltage across the shunt resistor of divider D_{I}. The resulting analogue signal I_{supply,meas} is representative of the supply current. Also the supply voltage U_{supply} may be represented by the averaged voltage U_{supply,meas} from divider D_{U}.

The analogue control signals I_{lamp,meas}, U_{lamp,meas}, U_{supply,meas} and I_{supply,meas} are fed to the interface controller (IFC) that converts the signals into usable indication signals for the microcontroller. Thereto each of the analogue control signals is converted into a corresponding digital control signal by one or more A/D-converters provided in control circuitry (1). The control circuitry (1) may convert each of the analogue control signals into corresponding digital control signals using a corresponding number of AID-converters, that is one A/D-converter for each the control signal. However, the microcontroller may also be programmed to use less A/D-converters, or even only one A/D-converter in combination with a multiplexer for converting the analogue control signals into corresponding digital control signals.

Once the analogue control signals are converted into a digital form, they are processed by the microcontroller (MC). Each of the digital control signals is filtered by using a digital filter, in this embodiment a software filter.

In general a first order software filter can be described as:
O_{N}=I_{N-1}*kI_{N-2}*k²+ . . . +I_{N-M}*k^{M}
wherein O stands for the output result of the filter, k an arbitrary number between 0 and 1, and I_{N} for the N^{th} input signal. Implemented in software this yields for a specific type of filter:
O_{N}=(1/X)*I_{N}+(X−1)/X*O_{N-1}
wherein X is an integer. If X is large, then the cut-off frequency will be small. When X is small, the cut-off frequency of the filter will be high.

The step response of a hardware-implemented analogue first order filter is a continuous function:
O=(1−e^{(-t/RC)})
wherein t is the time and RC is constant. In a software-implemented filter the response time depends on X and on the repetition sample speed of the input signal. Suppose the digital filter is implemented as follows:
O_{N}=0,25I_{N}+0,75O_{N-1}
Then the “new” input sample contribution to the result O_{N} is a quarter and the contribution of the “old” output sample to the “new” output signal is ¾. If X is increased from 4 to 8, the contribution of the “new” input sample will be reduced to ⅛. If a “stronger” filter is needed, then two first order filters are placed in series in order to create a second order filter with corresponding second order filter characteristics and so on.

In FIGS. 2 and 3 further simplified representations of other embodiments of the operating device according to the invention are given. FIG. 2 shows a switched mode power supply, which drives a lamp. Various lamp parameters, such as lamp voltage, lamp current, lamp power, etc, can be determined by a first measuring unit, a second measuring unit, etc. The measuring unit may be of a conventional type. Each measuring unit supplies one or more analogue output signals representative of the determined lamp parameters to an analogue-to-digital converter which provides digital output signals representative of the analogue input signals. Then the digital output control signals are supplied to a filter. The filter is implemented in a microcontroller, which comprises a processing unit for processing the digital control signal so as to provide a digitally filtered output signal to a microcontroller (MC) which controls the switched-mode power supply (SMPS). Based on the received digital output signal of the filter the microcontroller controls the power supplied to the lamp by the switched mode power supply. In this embodiment the analogue-to-digital converter(s), the filter(s) and the microcontroller (MC) are implemented in separate electronic circuits. In FIG. 3 an embodiment is shown wherein the analogue control signals from the first and second measuring unit are provided to one A/D-converter which samples in succession the first parameter, such as the lamp current I_{lamp,meas}, and the second parameter, such as the lamp voltage U_{lamp,meas}. In this embodiment samples are successively taken from the different measuring units, while the sample rate is chosen such that each measuring unit may communicate enough samples to the control circuit so as to enable the control circuitry to assure a sufficient fast and accurate control of the power supplied to the lamp. Furthermore, the control circuitry for controlling the switched mode power supply (SMPS) and filter circuitry, in the embodiment of FIG. 3, are combined. The filter function and power control function can both be implemented in one microcontroller.

In FIG. 4 a block diagram is shown of another preferred embodiment of the present invention. In this embodiment the digital filtering is achieved by storing the digital control data into an array of N entrees long. The array has a first-in first-out (FIFO) structure which means that the oldest sample will be shifted out at the moment a new sample has to be placed into the array. The array is accumulated with different weight factors per entry so a programmable moving average filter with a sinc-shaped frequency response is achieved.

The present invention is not limited to the above-described preferred embodiments thereof; the rights sought are defined by the following claims, within the scope of which many modifications can be envisaged.

1. Device for operating a discharge lamp, comprising:
a power supply circuit for supplying power to the discharge lamp from a supply voltage,
means for measuring at least one of the actual lamp current, the actual lamp voltage and the actual lamp power, providing at least one analogue lamp control signal representative of the lamp current, the lamp voltage and the lamp power respectively;
filter means for filtering the at least one lamp control signal;
control means for controlling the power supplied by the power supply circuit, wherein the at least one filtered lamp control signal is fed into the control means and the control means control the power depending on the at least lamp control signal; wherein the filter means comprise converting means for converting the at least one analogue lamp control signal to a corresponding digital lamp control signal and in that the filter means comprise a digital filter for filtering the digital lamp control signal into a filtered digital lamp control signal.

2. Device according to claim 1, wherein the digital filter is software-controllable.

3. Device according to claim 1, wherein the filter is adapted so as to control the characteristics of the digital filter during operation of the discharge lamp.

4. Device according to claim 1, wherein the converting means comprise a first analogue-to-digital (A/D-) converter for sampling a first lamp control signal and a second analogue-to-digital (A/D-) converter for sampling a second lamp control signal.

5. Device according to claim 1, wherein the converting means comprise one analogue-to-digital (A/D-) converter for successively sampling each of the lamp control signals.

6. Device according to claim 1, wherein the digital filter is a first order filter.

7. Device according to claim 6, wherein the first order filter processes the digital lamp control signal according to
$${O}_{N} = \frac{1}{X} {I}_{N} + \frac{X - 1}{X} {O}_{N - 1}$$
wherein O_{N} is the filtered digital lamp control signal for time point N, O_{N-1} is the filtered lamp control signal for time point N-1, I_{N} is the digital lamp control signal on time point N and X is a software-controllable filter parameter.

8. Device according to claim 7, wherein X is a preset integer.

9. Device according to claim 6, wherein the digital filter comprises two first order filters in series.

10. Device according to claim 1, wherein the digital filter comprises a buffer array for storing of a plurality of input samples of the digital lamp control signal and means for processing at least a part of said plurality of input samples in the buffer array to provide an output sample of the digital control signal.

11. Device according to claim 10, wherein the buffer array has a first-in first-out (FIFO) structure.

12. Device according to claim 10, wherein to each sample of the plurality of input samples of the digital lamp control signal a different weight factor is applied, whereafter the weighted input samples are summed to provide the output sample of the digital control signal.

13. Device according to claim 10, wherein the digital filter is a moving average filter.

14. Device according to claim 1, wherein the filter means and control means are implemented in one microcontroller.

15. Device according to claim 1, wherein the filter means and control means are implemented in a special purpose digital signal processor (DSP).

16. Method for operating a discharge lamp, comprising the steps of:
measuring at least one of the actual discharge lamp current, the actual discharge lamp voltage and the actual discharge lamp power, providing at least one analogue lamp control signal representative of the lamp current, the lamp voltage and the lamp power respectively;
converting the at least one analogue lamp control signal to a corresponding digital lamp control signal;
digitally filtering the at least one lamp control signal;
providing the digitally filtered lamp control signal to a control circuit;
controlling the power supplied to the discharge lamp based on the digitally filtered lamp control signal provided to the control circuit.

17. Method according to claim 16, wherein the at least one control signal is filtered under software control.

18. Method for operating a discharge lamp, comprising the steps of:
measuring at least one of the actual discharge lamp current, the actual discharge lamp voltage and the actual discharge lamp power, providing at least one analogue lamp control signal
